(19) United States
(12) Patent Application Publication
(10) Pub. No.: US 2025/0147389 A1
(43) Pub. Date: May 8, 2025

(54) LIGHTING SYSTEM FOR CAMERA

(71) Applicant: FORENSIC TECHNOLOGY (CANADA) INC., St-Laurent (CA)

(72) Inventors: Nicolas MOURET, Verdun (CA); Khac TRUONG NGUYEN, Laval (CA); Tomasz DRAKE, Montreal (CA)

(21) Appl. No.: 18/833,093

(22) PCT Filed: Jan. 26, 2023
(86) PCT No.: PCT/CA2023/050097

§ 371 Date: Jul. 25, 2024

Related U.S. Application Data
(60) Provisional application No. 63/267,208, filed on Jan. 27, 2022.

(51) Int. Cl. G03B 15/05; H04N 23/56

(52) U.S. Cl. CPC G03B 15/05; H04N 23/56; G03B 2215/0521; G03B 2215/0539; G03B 2215/0575

(57) ABSTRACT

A lighting system for a camera, has: a light board having a central axis, the light board having fingers circumferentially distributed about the central axis, the light board having a concave side, a finger of the fingers extending along a finger axis from a proximal end to a distal end and includes sections distributed along the finger axis from the proximal end to the distal end, a section of the sections pivotable relative to a remainder of the fingers; light sources secured on the fingers on the concave side of the light board, the light sources located on respective sections of the sections; and a controller operatively connected to each of the light sources and operable to independently control each of the light sources

### CROSS-REFERENCE TO RELATED APPLICATIONS

This application claims priority from U.S. patent application 63/267,208 filed on Jan. 27, 2022, the entire contents of which are incorporated by reference herein.

### TECHNICAL FIELD

This disclosure generally relates to the field of high-definition imaging and, more particularly, to a system to provide light to an object to be photographed using a high-definition camera and to a method of manufacturing said system.

### BACKGROUND OF THE ART

In the field of forensic science, an object, such as a casing of a bullet or a projectile, may be photographed using a high-definition camera for subsequent analysis. In some cases, a plurality of images are taken and combined to create a three-dimensional image of the object. To do so, the object is lit from different angles. A plurality of light sources may be distributed around the object and successively powered on to generate the images. However, existing structures encompassing those light sources are complicated to manufacture and expensive. Hence, improvements are sought.

### SUMMARY

In one aspect, there is provided a lighting system for a camera, comprising: a light board shaped as a dome and having a central axis, the light board having fingers circumferentially distributed about the central axis, a finger of the fingers extending along a finger axis from a proximal end to a distal end and includes sections distributed along the finger axis from the proximal end to the distal end, each two adjacent ones of the sections pivotable one relative to the other about a pivot axis; light sources secured on the fingers on a concave side of the light board, each of the light sources located on a respective one of the sections; and a controller operatively connected to each of the light sources and operable to independently control each of the light sources.

The lighting system may include any of the following features, in any combinations.

In some embodiments, the fingers are part of a first light board of the light board, the first light board made of a material being deformable.

In some embodiments, the material is plastically deformable.

In some embodiments, the material is aluminum or copper.

In some embodiments, a second light board has second fingers, each of the fingers of the first light board disposed circumferentially between two of the second fingers of the second light board.

In some embodiments, a retaining ring is engaged to the distal ends of each of the fingers for maintaining a shape of the light board.

In some embodiments, the fingers define cut-outs between each two adjacent ones of the sections, the cut-outs defining a local decrease in width of the fingers, the width taken in a direction transverse to the finger axis.

In some embodiments, each of the fingers includes a lateral panel and a connector affixed to the lateral panel, the connector operatively connected to the controller.

In another aspect, there is provided a system including a camera secured to the lighting system as described above.

In yet another aspect, there is provided a method of manufacturing a lighting system for a camera, comprising: obtaining a light board having fingers distributed around a central axis and light sources secured to the fingers; imparting a dome shape to the light board; and locking the light board in the dome shape.

The method may include any of the following features, in any combinations.

In some embodiments, the imparting of the dome shape includes bending the light board against a mold, the mold defining a negative of the dome shape.

In some embodiments, the method includes securing the light board to an apex of the mold before the bending of the light board against the mold.

In some embodiments, each of the fingers defines sections pivotable one relative to each other about pivot axes, the bending of the light board against the mold includes pivoting the sections about the pivot axes until each of the sections abuts an outer face of the mold.

In some embodiments, the locking of the light board in the dome shape includes securing a retaining ring to distal ends of the fingers.

In some embodiments, the method includes fastening the distal ends of the fingers to the retaining ring.

In some embodiments, the method includes obtaining a second light board having second fingers distributed around the central axis and second light sources secured to the second fingers.

In some embodiments, the method includes imparting the dome shape to the second light board and securing the second light board to the light board with each of the second fingers being interspaced with the fingers.

In some embodiments, the method includes operatively connecting each of the light sources such that each of the light sources is independently controllable by a controller.

In another aspect, there is provided a lighting system for a camera, comprising: a light board having a central axis, the light board having fingers circumferentially distributed about the central axis, the light board having a concave side, a finger of the fingers extending along a finger axis from a proximal end to a distal end and includes sections distributed along the finger axis from the proximal end to the distal end, a section of the sections pivotable relative to a remainder of the fingers; light sources secured on the fingers on the concave side of the light board, the light sources located on respective sections of the sections; and a controller operatively connected to each of the light sources and operable to independently control each of the light sources.

The lighting system described above may include any of the following features, in any combinations.

In some embodiments, the light sources are register with a curved surface extending around the central axis.

In some embodiments, each of the sections of the finger defines a respective angle relative to a main finger panel of the finger.

In some embodiments, the sections includes a first section and a second section located radially outwardly of the first section relative to the central axis, a first angle defined between the first section and the main finger panel being less than a second angle defined between the second section and the main finger panel.

In some embodiments, the sections of the finger are secured to the main finger panel via respective living hinges.

In some embodiments, the living hinges are defined by one or more tab interconnecting a respective one of the sections to the main finger panel.

In some embodiments, the fingers are made of a material being deformable.

In some embodiments, the material is plastically deformable.

In some embodiments, a support ring is engaged to the fingers for maintaining a shape of the light board.

In some embodiments, a base is secured to the light board, the controller mounted to the base.

In some embodiments, the base includes plates axially spaced apart from one another relative to the central axis, the controller being a printed circuit board secured to one of the plates.

In some embodiments, wires are electrically connected to the controller and protruding radially outwardly from the base from first ends at the base to second ends engaged to connectors of the fingers.

In some embodiments, the wires are disposed adjacent an opposite convex side of the light board.

In yet another aspect, there is provided a method of manufacturing a lighting system for a camera, comprising: obtaining a light board having fingers distributed around a central axis and light sources secured to the fingers; imparting a dome shape to the light board; and locking the light board in the dome shape.

The method described above may include any of the following features, in any combinations.

In some embodiments, the obtaining of the light board having the fingers includes obtaining a plurality of fingers, the method comprising securing the plurality of fingers to a base of the lighting system.

In some embodiments, the imparting of the dome shape includes securing the plurality of fingers to the base with an angle to provide the light board with a concave side.

In some embodiments, the imparting of the dome shape further includes bending finger sections of fingers relative to main finger panels of the fingers such that the light sources mounted on the finger sections are in register with a curved surface.

In some embodiments, each of the fingers defines sections pivotable one relative to each other about pivot axes, the method including pivoting the finger sections about the pivot axes.

In some embodiments, the finger sections of a finger of the fingers includes a first section and a second section located radially outwardly of the first section relative to the central axis, the pivoting of the finger sections includes pivoting the first section until a first angle defined between the first section and the main finger panel and pivoting the second section until a second angle, greater than the first angle, is defined between the second section and the main finger panel.

In some embodiments, the method includes operatively connecting each of the light sources to a controller such that each of the light sources is independently controllable by the controller.

Many further features and combinations thereof concerning the present improvements will appear to those skilled in the art following a reading of the instant disclosure.

### DESCRIPTION OF THE DRAWINGS

FIG. 1 is a bottom three dimensional view of a camera equipped with an optical lens and a lighting system in accordance with one embodiment;

FIG. 2 is a top three dimensional view of the optical lens and lighting system of FIG. 1;

FIG. 3 is a three dimensional exploded view of the optical lens and lighting system of FIG. 1;

FIG. 4 is a planar view of a light board of the lighting system of FIG. 1;

FIG. 5 is an enlarged view of a finger of the light board of FIG. 4;

FIG. 6 is a top view of the light board showing a printed circuit and light sources thereof;

FIG. 7 is an enlarged view of portion of the printed circuit located on one of the fingers of the light board of FIG. 4;

FIG. 8 is a flowchart illustrating a method of manufacturing the lighting system of FIG. 1;

FIG. 9 is a three dimensional view of the light board secured to a mold or punch;

FIG. 10 is a three dimensional view of the light board being bended against the mold or punch;

FIG. 11 is a cross-sectional view of the light board being bended against the mold or punch;

FIG. 12 is a cross-sectional view of the light board secured to a retaining ring;

FIG. 13 is a bottom view of the light board secured to the retaining ring;

FIG. 14 is a top three dimensional view of a lighting system in accordance with another embodiment;

FIG. 15 is a bottom three dimensional view of the lighting system of FIG. 14;

FIG. 16 is a three dimensional exploded view of the lighting system of FIG. 14;

FIG. 17 is another three dimensional exploded view of the lighting system of FIG. 14;

FIG. 18 is a three dimensional enlarged view of a finger of the lighting system of FIG. 14;

FIG. 19 is a three dimensional view of a bending tool shown in an open configuration;

FIG. 20 is a three dimensional view of the bending tool of FIG. 19 shown in a closed configuration;

FIG. 21 is a cross-sectional view of the bending tool of FIG. 19 in the closed configuration; and

FIG. 22 is a schematic representation of a controller for any of the lighting systems of FIG. 1 and FIG. 14.

### DETAILED DESCRIPTION

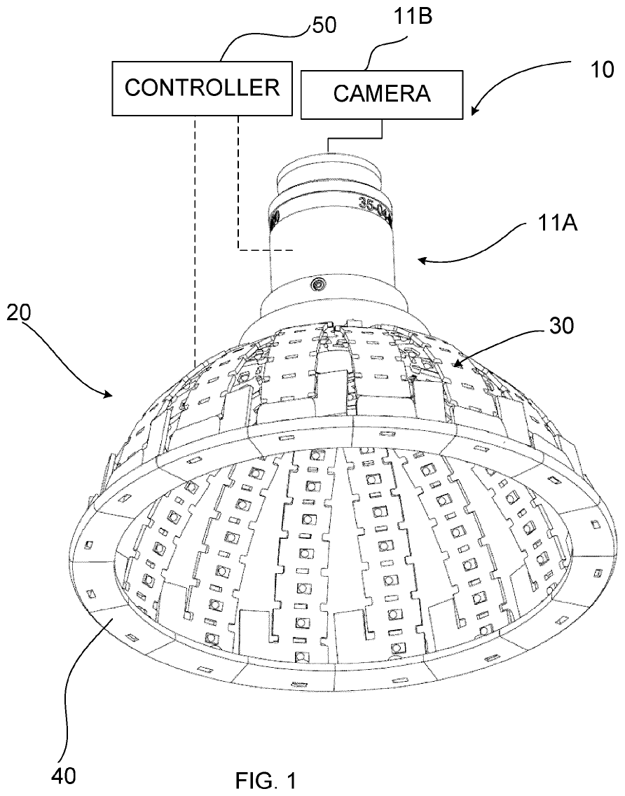

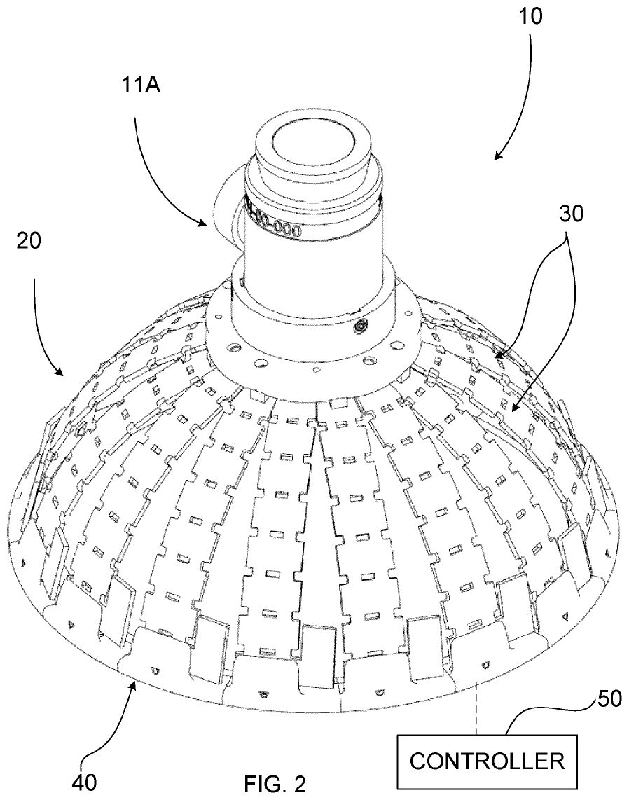

Referring to FIGS. 1-2, a system for capturing high-definition images of an object, such as a casing of a bullet or a projectile fired by a firearm, for subsequent analysis, is shown at 10. The system 10 includes an optical lens 11A, which is configured to be mounted to a camera 11B, and a lighting system 20 secured to the optical lens 11A. The lighting system 20 has a dome shape and is used to provide light to the object. The dome shape may be hemispherical. It may alternatively frustoconical, conical, paraboloid, hemi-ellipsoidal, and so on. The dome shape has a concave side facing a focal point where the object to be analyzed is located to be photographed by the camera 11A. The lighting system 20 has one or more light boards 30, two in the embodiment shown, and a retaining ring 40 secured to the one or more light boards 30 to maintain the dome shape. In the embodiment shown, the lighting system 20 includes two light boards 30 but more or less is contemplated. The lighting system 20 and the camera 11A may be operatively connected to a controller 50 as will be explained further below.

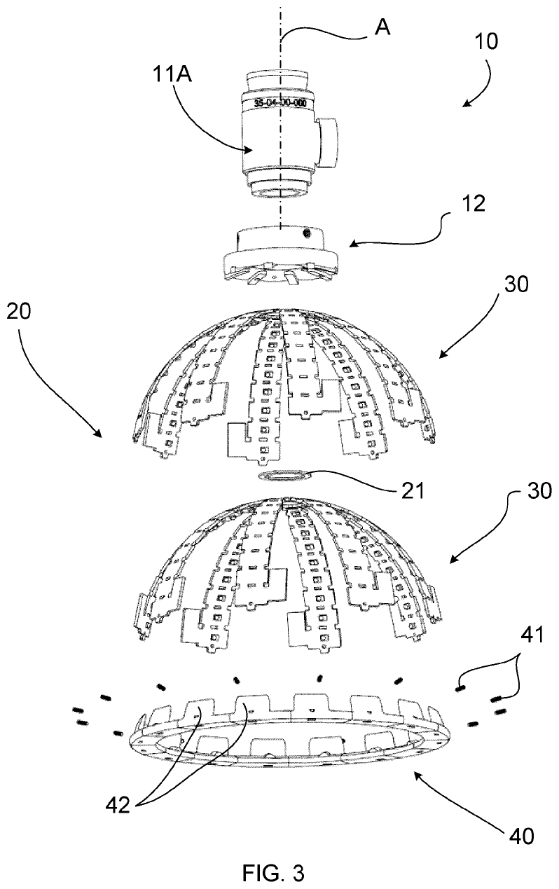

Referring to FIG. 3, in the embodiment shown, the two light boards 30 are disposed one over the other and are axially offset one relative to the other relative to a central axis A of the lighting system 20. The retaining ring 40 may be secured to free ends of the light boards 30 to impart stiffness to the assembly. Fasteners 41 may be used to secure the light boards 30 to the retaining ring 40. In the embodiment shown, an adaptor 12 is used to secure the optical lens 11B to the lighting system 20. A spacer 21 may be disposed between the two light boards 30.

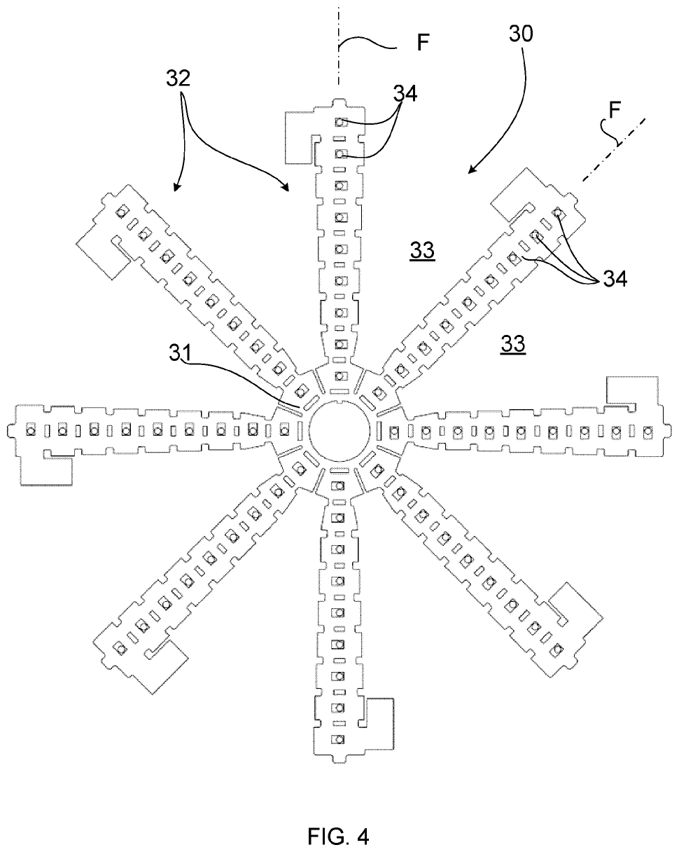

Referring now to FIG. 4, one of the two light boards 30 is shown and described below in greater detail. The below description will refer to the light board 30 using the singular form. However, it is understood that the description below may apply to each of the light boards 30.

The light board 30 has a central section 31 and a plurality of fingers 32 protruding radially from the central section 31 relative to the central axis A (FIG. 3). The fingers 32 are circumferentially spaced from one another relative to the central axis A. A spacing 33 is provided between each two circumferentially adjacent ones of the fingers 32. These spacing 33 are sized to accommodate the fingers 32 of the other light board 30. Once assembled, the two light boards 30 are circumferentially offset from one another such that fingers 32 of one of the light boards are disposed circumferentially between the fingers 32 of the other of the light boards 30. Light sources 34 are provided on the fingers 32 and are distributed longitudinally along finger axes F of the fingers 32. The light sources 34 may be LEDs or any other suitable light source. The finger axes F extend in a direction having a radial component relative to the central axis A. The light sources 34 may be disposed on a concave or inner side of the lighting system 20 and are oriented toward the focal point of the optical lens 11B. The controller 50 is operatively connected to the light sources 34 and operable to individually control each of the light sources 34.

The light board 30 may be made of sheet metal using any suitable material such as, for instance, aluminum or copper. Put differently, the main structure of the light board 30 may include a single monolithic layer of material. A shape of the light board 30 may be stamped from sheet metal or other suitable material. The material used for the light board 30 may be able to plastically deform from an undeformed state in which the light board 30 is co-planar as shown in FIG. 4 to a deformed state in which the light board 30 has the dome shape shown in FIG. 3. Any other suitable material may be used. In some embodiments, any material that has a plasticity to enable the forming of the light board 30 in a dome shape may be used.

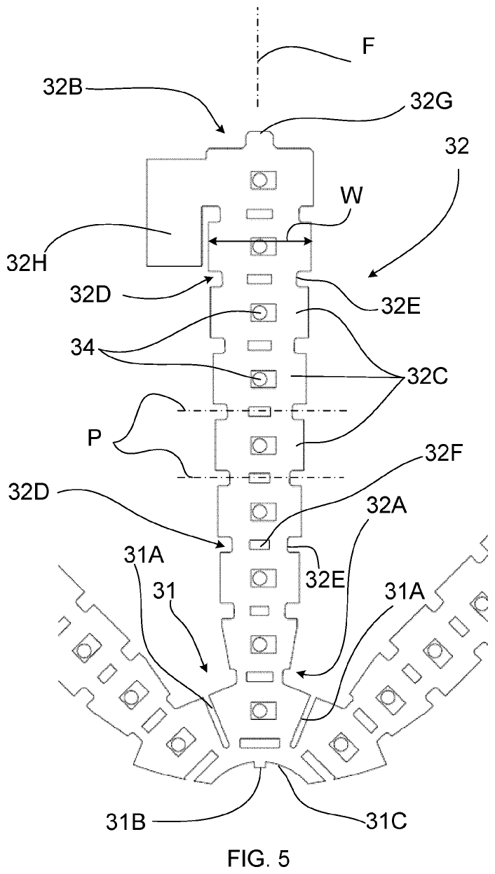

Referring more particularly to FIG. 5, one of the fingers 32 is shown in greater detail. In the embodiment shown, the fingers 32 extend along the finger axis F from a proximal end 32A at the central section 31 to a distal end 32B being radially spaced apart from the proximal end 32A relative to the central axis A. As shown, the central section 31 is substantially annular and defines a plurality of slits 31A circumferentially distributed around the central axis A. Each of the fingers 32 is circumferentially located between two adjacent ones of the slits 31A. The central section 31 may define a key 31B that extends radially inwardly relative to the central axis A and within a central aperture 31C of the central section 31. This key 31B may be used to locate the two light boards 30 relative to each other. The fingers 32 include a plurality of sections 32C distributed longitudinally along the finger axes F. Each of the sections 32C is equipped with one of the light sources 34. In some cases, more than one light sources may be provided on a single section.

The sections 32C are separated from one another by hinges 32D located at intersections between each two adjacent ones of the sections 32C. Each of the hinges 32D permits rotation of respective two adjacent ones of the sections 32C about a pivot axis P, which is generally transverse to the finger axis F. In the embodiment shown, the hinges 32D are living hinges. A living hinge may be made from the same material as the two rigid pieces it connects. Alternatively, the hinges may include any suitable mechanical hinges fastened to the sections 32C. In the present case, these hinges 32D are defined by a local decrease in a dimension of the fingers 32 in a direction normal to the finger axis F. In the present case, the hinges 32D are defined by a local decrease in a width W of the fingers 32. Put differently, a width of the fingers 32 is greater at the sections 32C than at the hinges 32D between two adjacent ones of the sections 32C. In the present case, this local decrease in width W is created by cut-outs 32E extending from peripheral edges of the fingers 32 toward the finger axis F. In the present embodiment, apertures 32F are defined through the fingers 32 between the cut-outs 32E at the hinges 32D. These cut-outs 32E and apertures 32F locally remove material from the fingers 32 thereby creating a weaker area to facilitate the bending of the fingers 32 from the co-planar shape shown in FIG. 4 to the dome shape of FIG. 3. In other words, a area moment of inertia of the fingers 32 at the sections 32C is greater than an area moment of inertia of the fingers 32 at the hinges 32D to ensure that the bending occurs at the hinges 32D and to minimize a moment of force transmitted to the sections 32C to avoid damaging the light sources 34 during the bending process and/or to avoid damaging a printed circuits located on substrate of the light board 30. This may be achieved in alternative ways. For instance, a thickness of the fingers 32 may be less at the hinges 32D than at the sections 32C to facilitate the bending of two sections one relative to the other about the pivot axes P. In some cases, both the width W and the thickness are reduced at the hinges 32D.

Each of the fingers 32 may define a tab 32G at the distal end 32B. The tabs 32G are used to secure the fingers 32 to the retaining ring 40 as will be described further below. The fingers 32 may further define lateral panels 32H that protrude transversally relative to the finger axis F and from the distal ends 32B of the fingers 32. These lateral panels 32H are sized to receive connectors used to connect the light sources 34 to the controller 50 as will be described below. These lateral panels 32H may be located at any other suitable locations on the fingers 32 or on the central section 31.

The sections 32C may be substantially greater than footprints of the light sources 34 to provide a surface free of the light sources 34 and exposed to ambient air for cooling purposes. In other words, the surface of the sections 32C free of the light sources 34 may be heated by the light sources 34 via conduction and may transfer its heat to ambient air via convection.

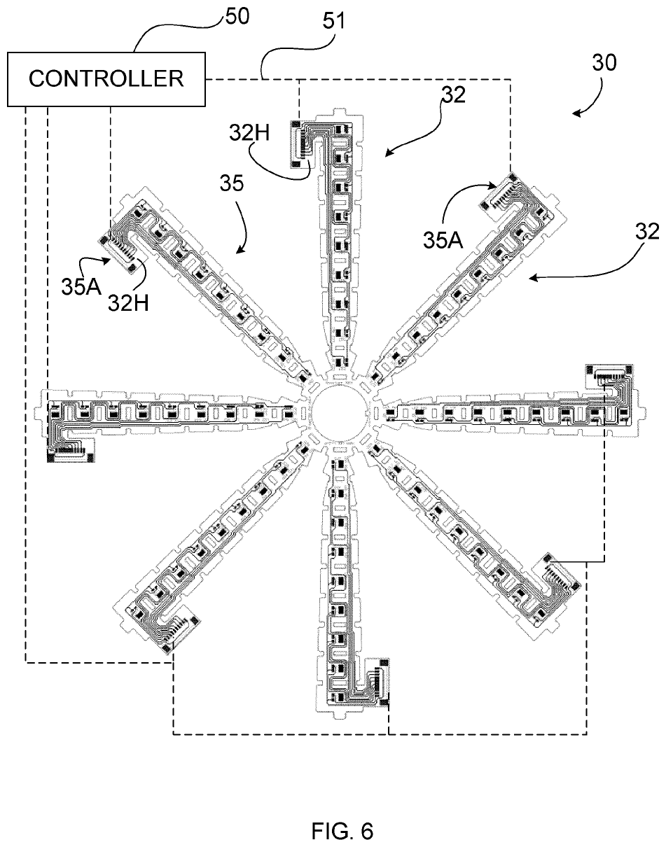

Referring now to FIGS. 6-7, the light board 30 includes a circuit 35 used to electrically connect the light sources 34 to the controller 50. The circuit 35 includes connectors 35A each disposed on a respective one of the lateral panels 32H of the fingers 32. The connectors 35A may be operatively connected to the controller 50 via suitable links 51, such as wires. In some embodiments, the light sources 34 may be wirelessly connected to the controller 50.

As shown more distinctly in FIG. 7, the circuit 35, which may be a printed circuit affixed to the substrate of the light board 30, includes a plurality of wires 35B for electrically connecting the connector 35A to the light sources 34. More specifically, the connector 35A includes a main connection point 35C and a plurality of secondary connection points 35D. The main connection point 35C is connected to each of first terminals 34A of the light sources 34. Each of the plurality of secondary connection points 35D is connected to a respective one of second terminals 34B of the light sources 34. Thus, the main connection point 35C may be electrically connected to a first polarity (e.g., positive) of a power source, which is operatively connected to the controller 50, and the secondary connection point 35D may be electrically connected to a second polarity (e.g., negative) of the power source. The controller 50 may therefore power on and power off individually each of the light sources 34 via the circuit 35.

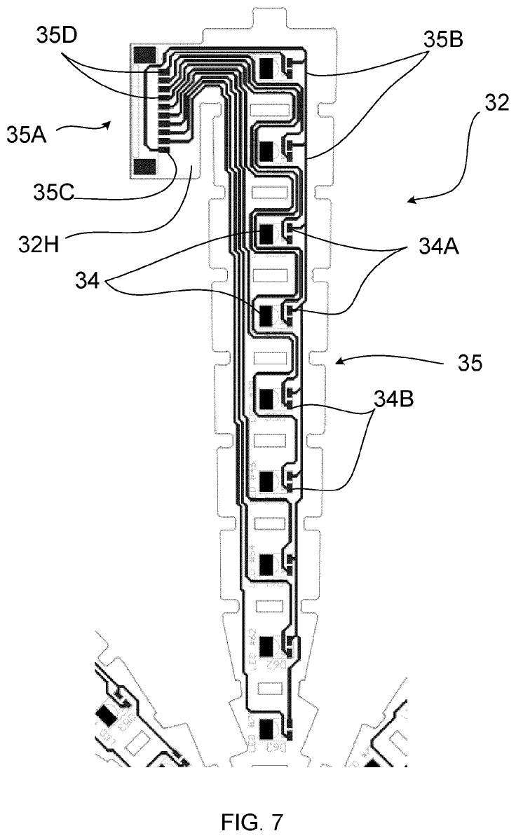

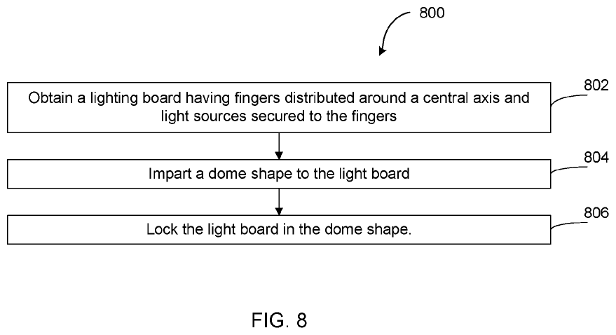

Referring now to FIG. 8, a method of manufacturing the lighting system 20 is shown at 800. The method 800 includes obtaining the light board 30 having the fingers 32 distributed around the central axis A and the light sources 34 secured to the fingers 32 at 802; imparting a dome shape to the light board 30 at 804; and locking the light board in the dome shape at 806. In some cases, the method 800 includes manufacturing a substrate of the light board 30. This may include stamping a shape of the substrate on sheet metal or other suitable material.

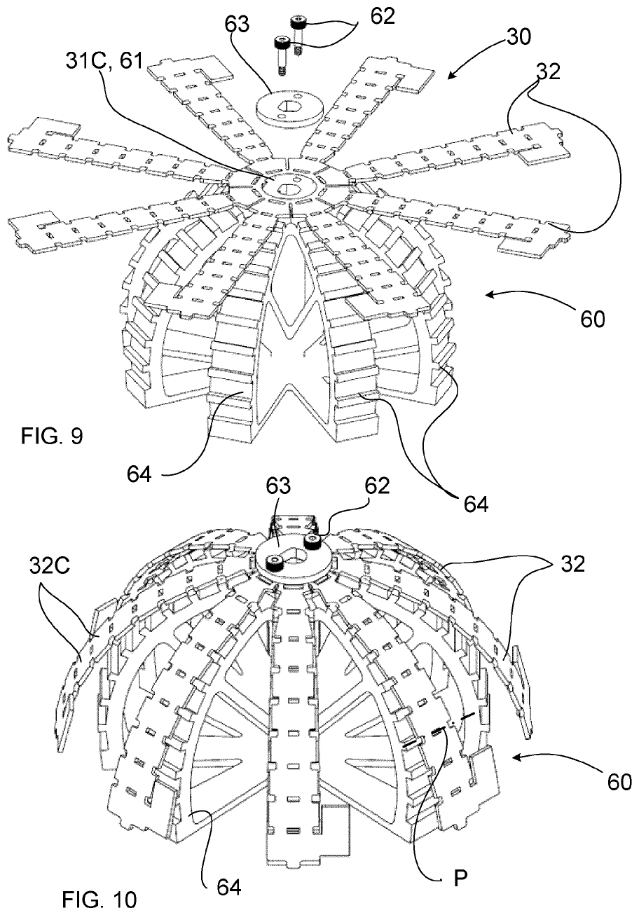

Referring more particularly to FIG. 9, in the present embodiment, the imparting of the dome shape at 804 may be achieved by bending the light board 30 against a mold 60. The mold 60 may be referred to alternatively as a punch. The mold 60 defines a negative of the dome shape. This may be achieved by fastening the light board 30 to an apex of the mold 60. In the embodiment shown, the mold 60 defines a protrusion 61 at the apex and sized to engage the central aperture 31C of the central section 31 of the light board 30. The key 31B (FIG. 5) may be used to prevent rotation of the light board 30 relative to the mold 60 about the central axis A. Fasteners 62 may be threadingly engaged to correspondingly threaded apertures of the protrusion 61 of the mold 60 to fix the light board 30 to the mold 60. A washer 63 may be used and disposed between the protrusion 61 of the mold 60 and heads of the fasteners 62.

Referring to FIGS. 9-10, the mold 60 may include a plurality of arms 64 circumferentially distributed about the central axis A. To impart the dome shape, each of the fingers 32 may be bent against a corresponding one of the arms 64 of the mold 60. This may be done manually by pushing the fingers 32 of the light board 30 against the arms 64 of the mold 60. In some other embodiment, a machine may be sued to bend the fingers 32 (e.g., hydraulic press). This may induce a plastic deformation of the fingers 32 at the hinges 32D such that the light board 30 substantially maintains the dome shape. In an alternative embodiment, the fingers 32 may deform elastically and maintain in their deformed shape with any suitable means (e.g., retaining ring 40). These steps may be carried for each of the light boards 30.

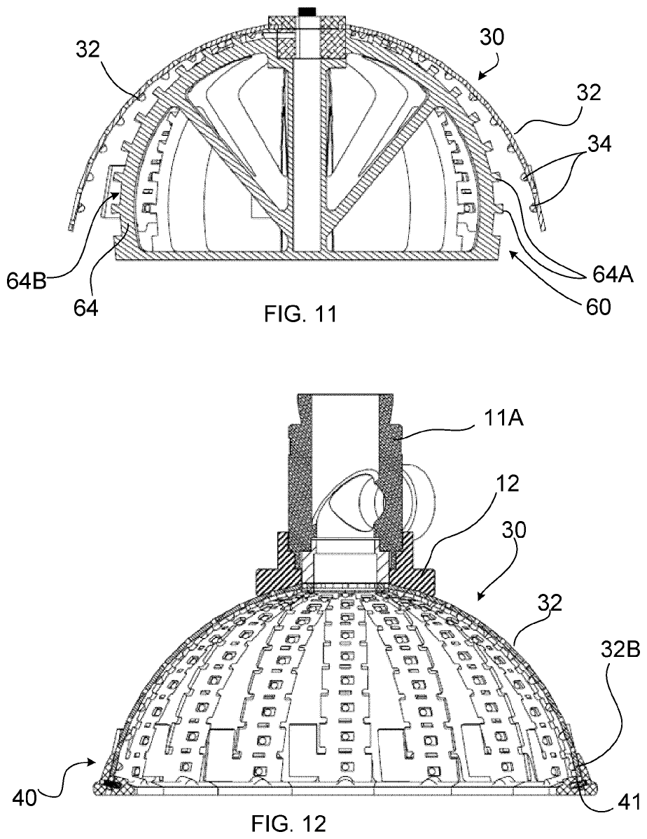

As shown in FIG. 11, each of the arms 64 of the mold 60 defines a plurality of protrusions 64A that extend away from a main body of the arms 64. Cavities 64B are defined between each two adjacent ones of the protrusions 64A. These cavities 64B are sized to receive the light sources 34 such that no pressure is exerted on the light sources 34 during the bending of the fingers 32 of the light board 30 at 804. These protrusions 64A and cavities 64B therefore allow a substrate of the light board 30 to be abutted against the mold 60 without damaging the light sources 34 that may slightly protrude out-of-plane from the substrate of the light board 30. The bending of the light board 30 against the mold 60 includes pivoting the plurality of sections 32C about the pivot axes P until each of the sections 32C abuts an outer face of the mold 60. The steps described above may be repeated for each light boards 30.

As shown in FIGS. 3 and 12, the step of locking the light board 30 in the dome shape at 806 may include securing the retaining ring 40 to the distal ends 32B of the fingers 32. This may be done by fastening the distal ends 32B of the fingers 32 to the retaining ring 40 with the fasteners 41. In the embodiment shown, the retaining ring 40 includes a plurality of tabs 42 (FIG. 3) circumferentially distributed about the central axis A. Each of the distal ends 32B of the fingers 32 may be secured to a respective one of the tabs 42.

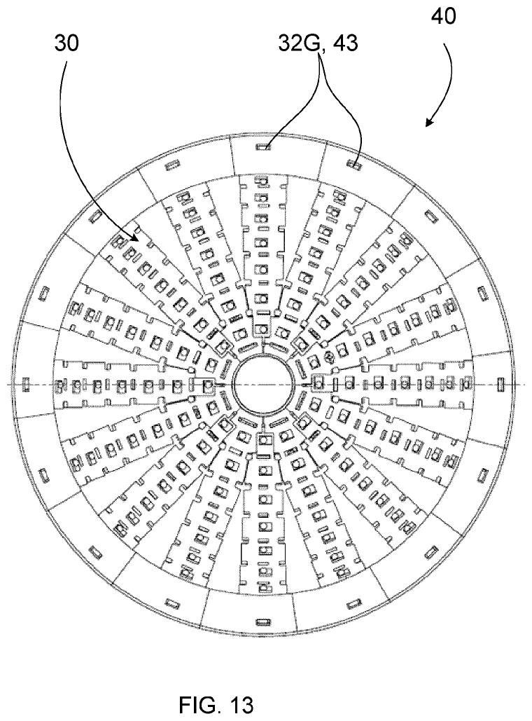

As shown in FIG. 13, the locking of the light board 30 in the dome shape at 806 may include inserting the tabs 32G located at the distal ends 32B of the fingers 32 into correspondingly shaped apertures 43 defined by the retaining ring 40. These tabs 32G may therefore maintain the fingers 32 in engagement with the retaining ring 40.

The method 800 may then include operatively connecting each of the light sources 34 to the controller 50 such that each of the light sources 34 is independently controllable by the controller 50. As shown in FIG. 7, the connecting of the light sources 34 may be achieved using the connectors 35A located on the lateral panels 32H of the fingers 32.

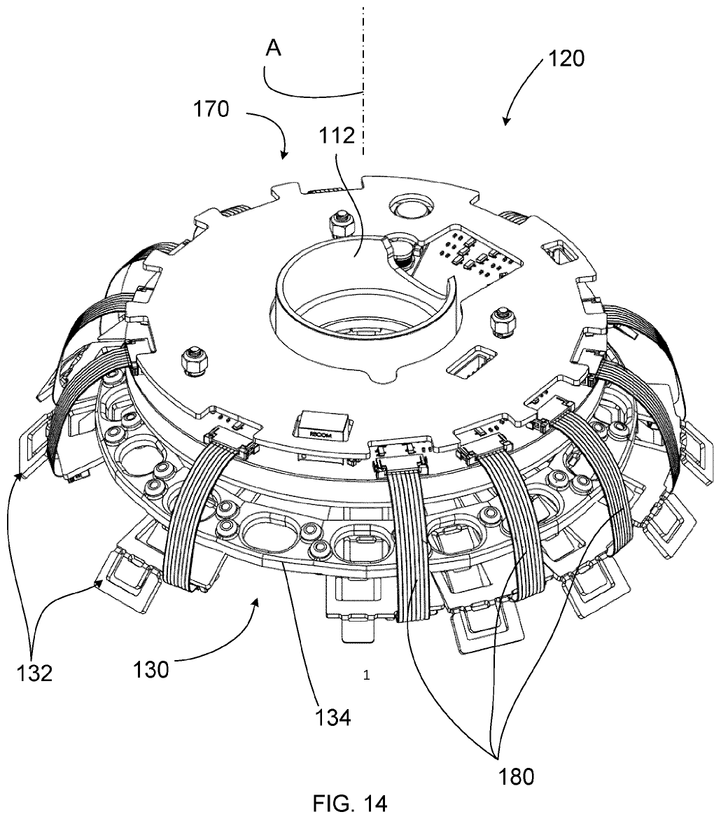

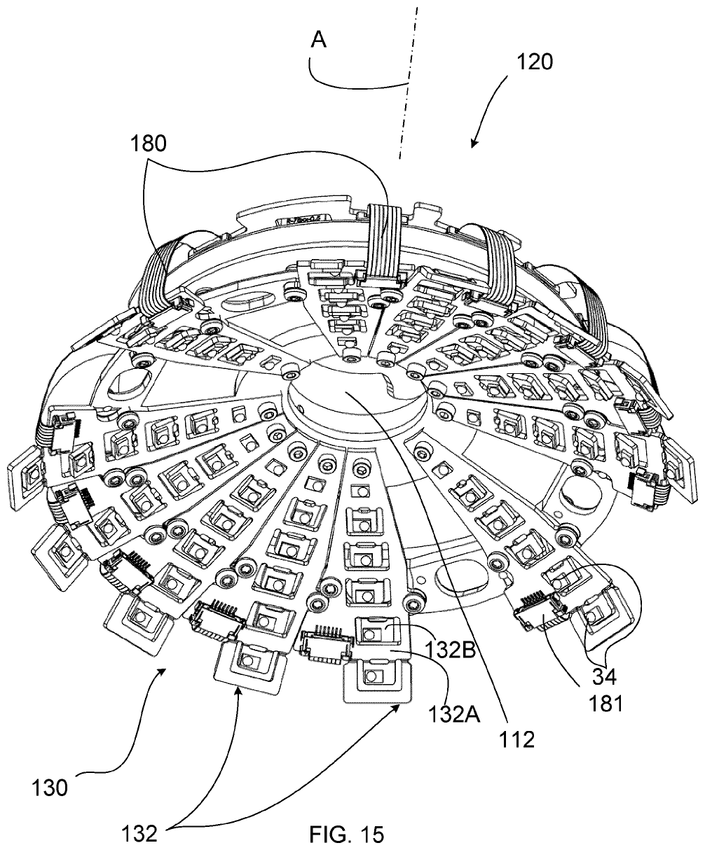

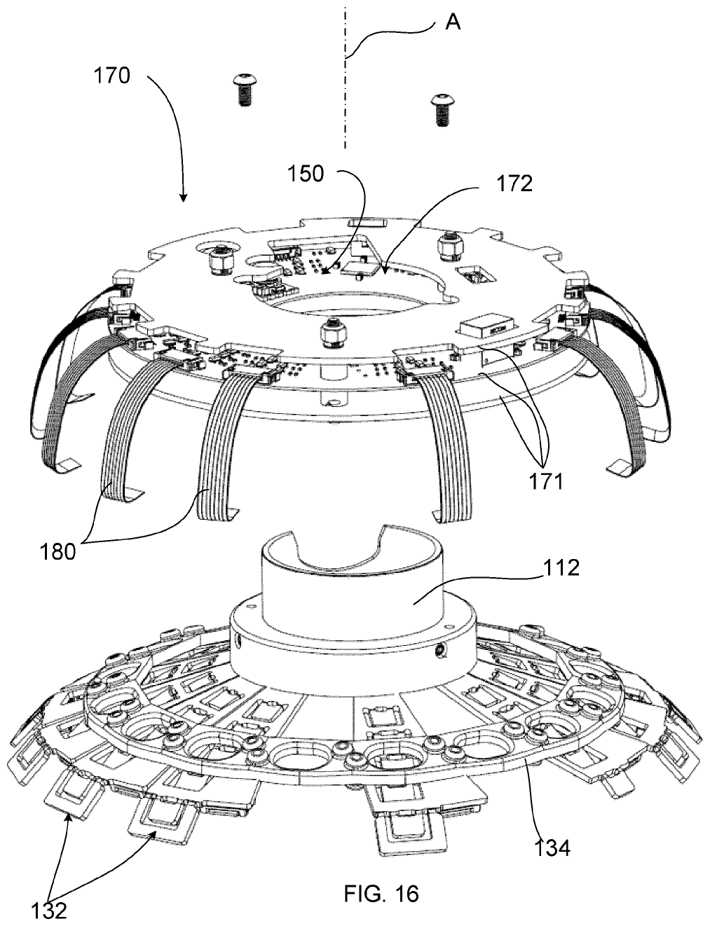

Referring now to FIGS. 14-15, another embodiment of a lighting system is shown at 120. The lighting system 120 includes a light board 130 secured to a base 170 that houses a controller 150 (FIG. 16) of the lighting system 120. The controller 150 is provided as a printed circuit board (PCB) and is operatively connected to wires 180. The wires 180 operatively connect the controller 150 to the light board 130. The wires 180 are flexible. The lighting system 120 includes an adaptor 112 secured to the base 170 and used to secure the optical lens 11B (FIG. 1) to the lighting system 120. As for the embodiment of FIG. 1, the lighting system 120 includes fingers circumferentially distributed about a central axis A. The light board 130 has a concave side. Light sources are secured on the fingers on the concave side of the light board 130.

Referring now to FIG. 16, the base 170 includes three plates 171 disposed atop one another and axially spaced apart from one another about the central axis A. Any suitable number of plates 171 is contemplated. The controller 150 may be secured to a central one of the three plates 171 and disposed between a top one of the three plates 171 and the central one of the three plates 171. Other locations of the controller 150 within the base 170 are contemplated. The plates 171 may be used to protect the controller 150. The three plates 171 define each a central aperture 172 sized to accept the adaptor 112. The optical lens 11B is therefore secured to the lighting system 120 via the adaptor 112, which is itself secured to the base 170.

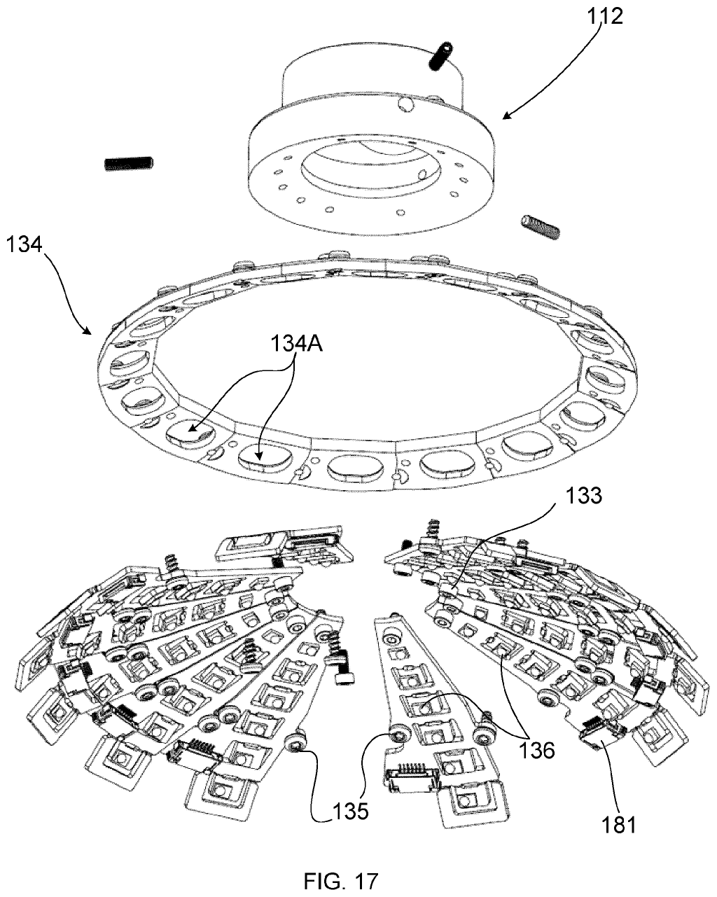

Referring to FIGS. 16-17, the light board 130 is herein provided as an assembly of a plurality of fingers 132 each being secured to the adaptor 112 via suitable fasteners 133 (FIG. 17). The fingers 132 have proximal ends secured to the adaptor 112 and distal ends radially offset form the proximal ends. The fingers 132 are further secured to a support ring 134 via fasteners 135, two fasteners for each fingers 32 in the present embodiment, but any suitable number of fasteners may be used. The support ring 134 is secured to the fingers 132 between their proximal and distal ends. The support ring 134 may add stiffness to the assembly of the light board 130. The support ring 134 may define a plurality of apertures 134A. These apertures 134A may reduce the weight of the support ring 134 while allowing air to reach the fingers 132 to cool down the light sources 136 secured to the fingers 132. The support ring 134 may also ensure proper radial alignment of the fingers 132. It will be appreciated that any suitable means for securing the fingers 132 to the adaptor 112 and to the support ring 134 are contemplated. For instance, clips, snap fit, hooks, keyway, brazing/welding, and so on may alternatively be used. The support ring 134 may be omitted in some configurations.

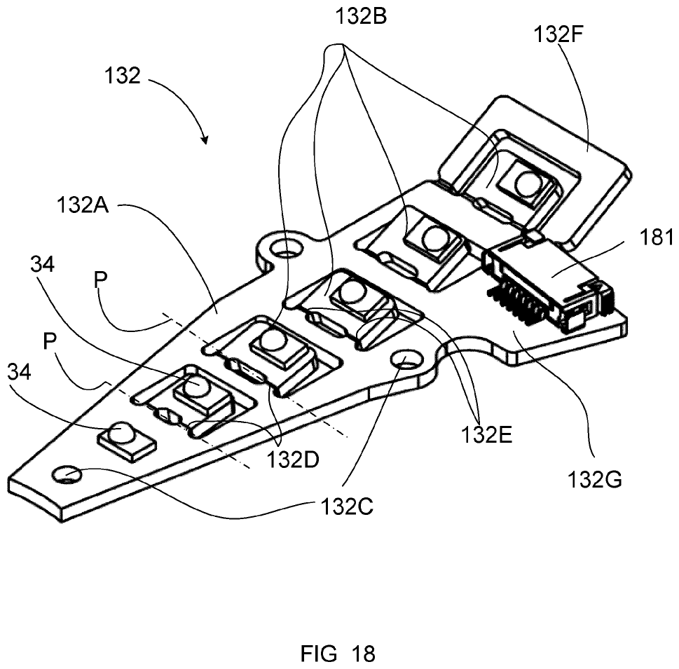

Referring now to FIG. 18, one of the fingers 132 is illustrated. The below description uses the singular form, but my apply to all of the fingers 132 of the light board 130.

The finger 132 includes a main finger panel 132A and finger sections 132B secured to the main finger panel 132A. The main finger panel 132A defines apertures 132C for receiving the fasteners 133, 135 for securing the finger 132 to the adaptor 112 and the support ring 134. The finger sections 132B are hingedly connected to the main finger panel 132A via hinges 132D that permit rotation of the finger sections 132B relative to the main finger panel 132A via respective pivot axes P. These hinges 132D may be living hinges as defined herein above. A living hinge may be made from the same material as the two rigid pieces it connects. Herein, the finger sections 132B and the main finger panel 132A may belong to the same monolithic part. Alternatively, the hinges may include any suitable mechanical hinges fastened to the finger sections 132B. In the present embodiment, a finger section 132B is secured to the main finger panel 132A via tabs 132E, two tabs in the present embodiment, although only one or more than two tabs may be used. These tabs 132E may be separated by a void to minimize a force required to bend the finger sections 132B relative to the main finger panel 132A. These tabs 132E may have a thickness of material less than that of the main finger panel 132A and/or less than a remainder of the finger sections 132B to ease the bending of the finger sections 132B. A distal one of the finger sections 132B may be secured to a distal panel 132F that may be hingedly connected to the main finger panel 132A via another living hinge or any other suitable means. These distal panel 132F may be used to protect the light sources 34 and the finger sections 132B when the lighting system 120 is laid on a surface (e.g., table) during its assembly. In other words, the distal panels 132F may define abutment surfaces to contact a surface (e.g., table). The main finger panel 132A has a lateral section 132G sized to accept a connector 181 via which the wires 180 may be electrically connected to the light sources 34. Although not illustrated in FIG. 18, each of the fingers 132 may be equipped with a circuit to electrically connect the connector 181 to the light sources 34. This circuit may be similar to the one depicted in FIG. 7.

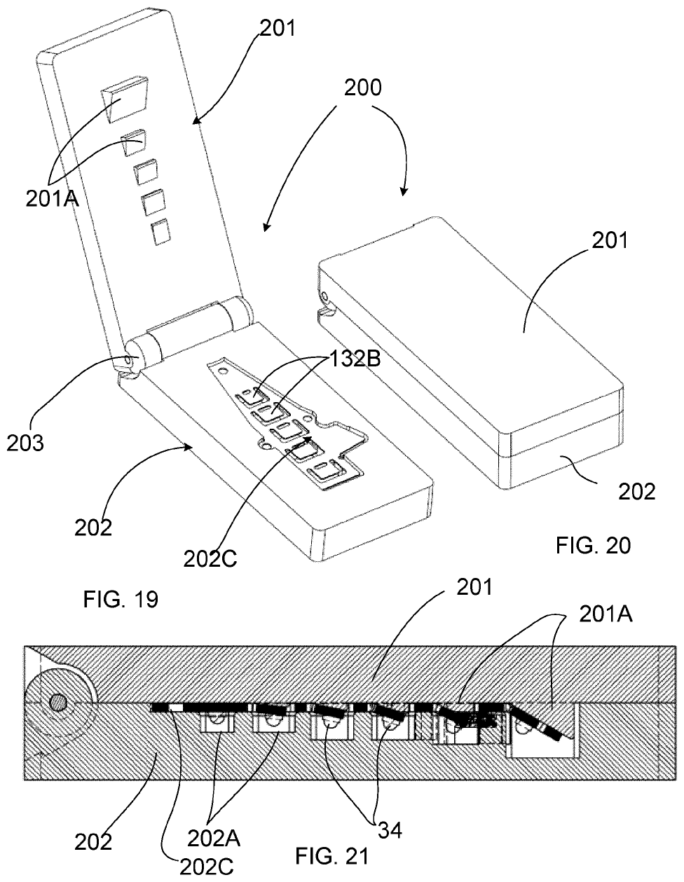

Referring now to FIGS. 19-21, in the present embodiment, the main finger panel 132A remains substantially straight and co-planar except for the distal panel 132F, and the finger sections 132B are bent at respective angles to orient the light sources 34 towards the focal point of the optical lens 11B (FIG. 1). More specifically, each of the finger sections 132B defines a respective angle relative to the main finger panel 132A. In some embodiments, the finger sections 132B include a first section and a second section located radially outwardly of the first section relative to the central axis A. A first angle defined between the first section and the main finger panel 132A is less than a second angle defined between the second section and the main finger panel 132A. Put differently, an angle between the finger section 132B and the main finger panel 132A increases as the finger section 132B is located further away from the central axis A. Stated differently, the further away the finger section 132B is from the central axis A, the greater is the angle defined between this finger section 132B and the main finger panel 132A. This may ensure that the light sources 34 secured to the respective finger sections 132B are properly angled to emit light toward the object to be photographed.

To do so, a bending tool 200 is used. The bending tool 200 may include a male tool section 201 and a female tool section 202 engageable to the male tool section 201. In the present embodiment, the male tool section 201 is hingedly connected to the female tool section 202 via a hinge 203. In some embodiments, the two tool sections may be separated from one another and guiding features (e.g., pins and slots, etc) may be used to ensure proper alignment when engaging the male tool section 201 to the female tool section 202.

The male tool section 201 includes protrusions 201A each in register with a respective one of cavities 202A of the female tool section 202. The female tool section 202 defines a finger receiving recess 202C sized to accept one of the fingers 132. In some embodiments, the finger receiving recess 202C may be defined by the male tool section 201 or may be omitted in some cases. To operate the bending tool 200, one of the fingers 132 is inserted into the finger receiving recess 202C of the female tool section 202. Then, the male tool section 201 is moved towards the female tool section 202, herein via a pivotal movement of the two sections one relative to the other, until each of the protrusions 201A abuts a respective one of the finger sections 132B. The male tool section 201 and the female tool section 202 are pressed towards one another so that the protrusions 201A exert force on the finger sections 132B of the finger 132 to bend the finger sections 132B relative to the main finger panel 132A to properly angle the finger sections 132B relative to the main finger panel 132A. During bending, the finger section 132B and the light sources 34 secured thereto are received within the cavities 202A, which are oversized to avoid the light sources 34 from abutting the female tool section 202 to avoid damaging the light sources 34. Then, the finger 132 is removed from the finger receiving recess 202C of the female tool section 202 and may be installed to the lighting system 120. As discussed above, the finger 132 may then be secured to the adaptor 112 and to the support ring 134 and the finger sections 132B are all properly angled such that the light sources 34 are adequately oriented relative to the object to be photographed.

Referring back to FIG. 15, in the present embodiment, the fingers 132 are secured to the adaptor 112 and protrude both radially and axially relative to the central axis A. The fingers 132 may thus substantially lie within a frustoconical surface annularly extending around the central axis A. The finger sections 132B, by being angled relative to the main finger panel 132A, may dispose the light sources 34 within or in register with a substantially curved/dome (e.g., spherical) surface.

Referring back to FIG. 8 with continued reference to FIG. 15, in the embodiment shown, the method 800 to manufacture the lighting system 120 may include the steps 802 to 806 as described above.

In this embodiment, the obtaining of the light board 130 having the fingers 132 may include obtaining a plurality of fingers. The method 800 may comprise securing the plurality of fingers to the base 170 of the lighting system 120. The imparting of the dome shape may include securing the plurality of fingers 132 to the base 170 with an angle to provide the light board with a concave side. The imparting of the dome shape may further include bending the finger sections 132B of the fingers 132 relative to the main finger panels 132A of the fingers 132 such that the light sources 34 mounted on the finger sections 132B are in register with a curved surface. Each of the fingers 132 may define the finger sections being pivotable one relative to each other about the pivot axes P (FIG. 18). The method may include pivoting the finger sections 132B about the pivot axes P. In the embodiment shown, the finger sections 132B of a finger 132 of the fingers 132 includes a first section and a second section located radially outwardly of the first section relative to the central axis A. The pivoting of the finger sections includes pivoting the first section until a first angle defined between the first section and the main finger panel 132A and pivoting the second section until a second angle, greater than the first angle, is defined between the second section and the main finger panel 132A.

Once the fingers 132 are assembled, each of the light sources may be operatively connected to the controller 150 such that each of the light sources is independently controllable by the controller 150.

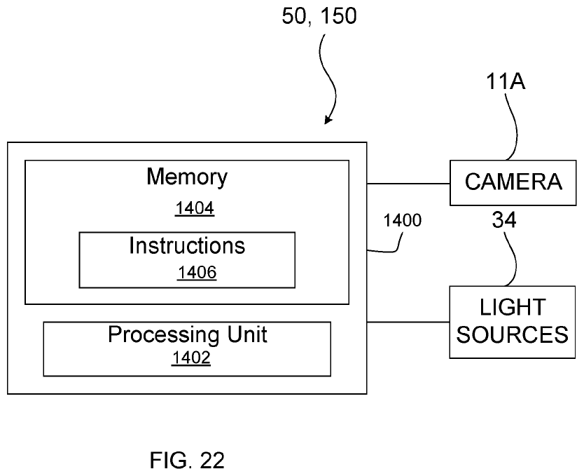

Referring now to FIG. 22, the controller 50, 150 is shown in greater the detail. The controller 50, 150 is operatively connected to the light sources 34 and to the camera 11A (FIG. 1). The controller 50, 150 may be operatively connected to the light sources 34 via the circuit 35. In some embodiments, a wireless connection may be provided between the controller 50, 150 and the light sources 34 and/or camera 11A.

The controller 50, 150 is able to execute a sequence of imaging by sequentially powering the different light sources 34 to expose the object with varying angles of light. The camera 11A may capture the images of the object exposed with the varying angles. The controller 50, 150 or other devices may gather the data form the different captured images and perform a numerical reconstruction to build a 3D model of the object based on the different captured images. Any known technique may be sued for this 3D reconstruction.

With reference to FIG. 14, an example of a computing device 1400 is illustrated. For simplicity only one computing device 1400 is shown but the system may include more computing devices 1400 operable to exchange data. The computing devices 1400 may be the same or different types of devices. The controller 50, 150 may be implemented with one or more computing devices 1400.

The computing device 1400 comprises a processing unit 1402 and a memory 1404 which has stored therein computer-executable instructions 1406. The processing unit 1402 may comprise any suitable devices configured to implement a method of capturing images of an object such that instructions 1406, when executed by the computing device 1400 or other programmable apparatus, may cause the functions/acts/steps performed as part of the method of capturing images of an object as described herein to be executed. The processing unit 1402 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 1404 may comprise any suitable known or other machine-readable storage medium. The memory 1404 may comprise non-transitory computer readable storage medium, for example, but not limited to, an electronic, magnetic, optical, electromagnetic, infrared, or semiconductor system, apparatus, or device, or any suitable combination of the foregoing. The memory 1404 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1404 may comprise any storage means (e.g., devices) suitable for retrievably storing machine-readable instructions 1406 executable by processing unit 1402.

The methods and systems for capturing images of an object described herein may be implemented in a high level procedural or object oriented programming or scripting language, or a combination thereof, to communicate with or assist in the operation of a computer system, for example the computing device 1400. Alternatively, the methods and systems for capturing images of an object may be implemented in assembly or machine language. The language may be a compiled or interpreted language. Program code for implementing the methods and systems for capturing images of an object may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for capturing images of an object may also be considered to be implemented by way of a non-transitory computer-readable storage medium having a computer program stored thereon. The computer program may comprise computer-readable instructions which cause a computer, or more specifically the processing unit 1402 of the computing device 1400, to operate in a specific and predefined manner to perform the functions described herein, for example those described in the method 400.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

As can be seen therefore, the examples described above and illustrated are intended to be exemplary only. The scope is indicated by the appended claims.

1. A lighting system for a camera, comprising:
a light board having a central axis, the light board having fingers circumferentially distributed about the central axis, the light board having a concave side, a finger of the fingers extending along a finger axis from a proximal end to a distal end and includes sections distributed along the finger axis from the proximal end to the distal end, a section of the sections pivotable relative to a remainder of the fingers;
light sources secured on the fingers on the concave side of the light board, the light sources located on respective sections of the sections; and
a controller operatively connected to each of the light sources and operable to independently control each of the light sources.

2. The lighting system of claim 1, wherein the light sources are register with a curved surface extending around the central axis.

3. The lighting system of claim 2, wherein each of the sections of the finger defines a respective angle relative to a main finger panel of the finger.

4. The lighting system of claim 3, wherein the sections includes a first section and a second section located radially outwardly of the first section relative to the central axis, a first angle defined between the first section and the main finger panel being less than a second angle defined between the second section and the main finger panel.

5. The lighting system of claim 3, wherein the sections of the finger are secured to the main finger panel via respective living hinges.

6. The lighting system of claim 5, wherein the living hinges are defined by one or more tab interconnecting a respective one of the sections to the main finger panel.

7. The lighting system of claim 1, wherein the fingers are made of a material being deformable.

8. The lighting system of claim 7, wherein the material is plastically deformable.

9. The lighting system of claim 1, comprising a support ring engaged to the fingers for maintaining a shape of the light board.

10. The lighting system of claim 1, comprising a base secured to the light board, the controller mounted to the base.

11. The lighting system of claim 10, wherein the base includes plates axially spaced apart from one another relative to the central axis, the controller being a printed circuit board secured to one of the plates.

12. The lighting system of claim 11, comprising wires electrically connected to the controller and protruding radially outwardly from the base from first ends at the base to second ends engaged to connectors of the fingers.

13. The lighting system of claim 12, wherein the wires are disposed adjacent an opposite convex side of the light board.

14. A method of manufacturing a lighting system for a camera, comprising:
obtaining a light board having fingers distributed around a central axis and light sources secured to the fingers;
imparting a dome shape to the light board; and
locking the light board in the dome shape.

15. The method of claim 14, wherein the obtaining of the light board having the fingers includes obtaining a plurality of fingers, the method comprising securing the plurality of fingers to a base of the lighting system.

16. The method of claim 15, wherein the imparting of the dome shape includes securing the plurality of fingers to the base with an angle to provide the light board with a concave side.

17. The method of claim 14, wherein the imparting of the dome shape further includes bending finger sections of fingers relative to main finger panels of the fingers such that the light sources mounted on the finger sections are in register with a curved surface.

18. The method of claim 17, wherein each of the fingers defines sections pivotable one relative to each other about pivot axes, the method including pivoting the finger sections about the pivot axes.

19. The method of claim 18, wherein the finger sections of a finger of the fingers includes a first section and a second section located radially outwardly of the first section relative to the central axis, the pivoting of the finger sections includes pivoting the first section until a first angle defined between the first section and the main finger panel and pivoting the second section until a second angle, greater than the first angle, is defined between the second section and the main finger panel.

20. The method of claim 14, comprising operatively connecting each of the light sources to a controller such that each of the light sources is independently controllable by the controller.
